(19) United States
(12) Patent Application Publication
(10) Pub. No.: US 2005/0160254 A1
(43) Pub. Date: Jul. 21, 2005

(54) Multithread processor architecture for triggered thread switching without any clock cycle loss, without any switching program instruction, and without extending the program instruction format

(75) Inventors: Jinan Lin, Ottobrunn (DE); Xiaoning Nie, Neubiberg (DE)

Correspondence Address: Maginot, Moore & Beck;Bank One Tower, Suite 3000, 111 Monument Circle, Indianapolis, IN, 46204, US

(73) Assignee: Infineon Technologies AG, Munchen (DE)

(21) Appl. No.: 11/015,299

(22) Filed: Dec. 17, 2004

(30) Foreign Application Priority Data
Dec. 19, 2003 (DE) 103 59 949.5

(51) Int. Cl. G06F 9/00

(52) U.S. Cl. 712/228

(57) ABSTRACT

A multithread processor based on the inventive architecture is a clocked multithread processor (1) for data processing of N threads by means of a standard processor root unit (2), wherein a thread Tⱼ which is to be processed at any given time by the standard processor root unit (2) can be switched without any clock cycle loss by means of a switching trigger signal (UTS) to another thread T₁, wherein the switching trigger signal (UTS) is generated as a consequence of a program instruction (which is fetched from a program instruction memory (3) and implies a latency time) for the thread Tⱼ which is to be processed at that time and results in a latency time for the standard processor root unit (2), before the program instruction which has been fetched and implies a latency time is decoded by the standard processor root unit (2).

The invention relates to an architecture for a multithread processor for triggered switching of threads, which are processed in a standard processor unit pipeline for a multithread processor, without any clock cycle loss, without use of any additional switching program instruction, and without extending the program instruction format.

A multithread processor according to the inventive architecture has a standard processor root unit for clocked data processing of N threads, wherein a thread Tⱼ which is to be processed at any given time by the standard processor root unit can be switched without any clock cycle loss by means of a switching trigger signal to another thread T₁, wherein the switching trigger signal is generated as a consequence of a program instruction (which is fetched from a program instruction memory and implies a latency time) for the thread Tⱼ which is to be processed at that time and results in a latency time for the standard processor root unit, before the program instruction which has been fetched and implies a latency time is decoded by the standard processor root unit.

Now that various methods for avoidance of latency times according to the prior art, such as instruction level paralleling (ILP) methods, such as multiple issue, out of order execution or prefetching have reached their technical limits, the aim of the invention is toleration of latency times while at the same time improving the utilization of the processor. The invention relates to the field of thread level paralleling (TLP), with a thread being processed until it is triggered to switch (switch-on trigger). The number of on-board threads is in this case scaleable (course-grained multithreading).

The invention is based on the known fact that latency times caused by program instructions for threads can be characterized on the basis of their duration and their occurrence. A latency time is characterized by its deterministic or non-deterministic occurrence, and by its deterministic or non-deterministic duration.

Short latency times are essentially of deterministic occurrence. Long latency times are essentially of non-deterministic occurrence.

Long latency times are dealt with in the same way as in conventional course-grained multithreading processors. The aim of the invention is to provide for threads to be switched without any clock cycle loss for latency times with deterministic occurrence.

Embedded processors and their architectures are measured by their power consumption, their throughput, their utilization, their costs and their real-time capability. The principle of pipelining is used in order to increase the throughput and the utilization. The basic idea of pipelining is based on the fact that any desired program instructions can be subdivided into processing phases of equal time duration. A pipeline with different processing elements is possible when the processing of a program instruction can itself be subdivided into a number of phases with disjunctive process steps which can be carried out successively. The original two instruction execution phases of the Von Neumann model, that is to say instruction fetching and instruction processing, are in this case further subdivided since division into two phases has been found to be too coarse for pipelining. The pipeline variant which is essentially used for RISC processors contains four phases for instruction processing, specifically instruction fetching, instruction decoding/operand fetching, instruction execution and write-back.

A thread T denotes a monitoring path for a code, a source code or a program, with data relationships existing within a thread T and weak data relationships existing between different threads T (as described in Chapter 3 of T. Baierlein, O. Hagenbruch: “Taschenbuch Mikroprozessortechnik” [Microprocessor technology handbook], 2nd edition, Fachbuchverlag Leipzig in the Karl Hanser Verlag Munich, Vienna, ISBN 3-446-21686-3).

One characteristic of a process is that a process always accesses its own memory area. A process comprises two or more threads. A thread is accordingly a program part of a process. A context of a thread is the processor state of a processor which is processing this thread or program instructions for this thread. The context of a thread is accordingly defined as a temporary processor state during the processing of that thread by this processor. The context is held by the hardware of the processor, specifically the program counting register PZR or program counter PC, the register file or context memory K and the status register SR associated therewith.

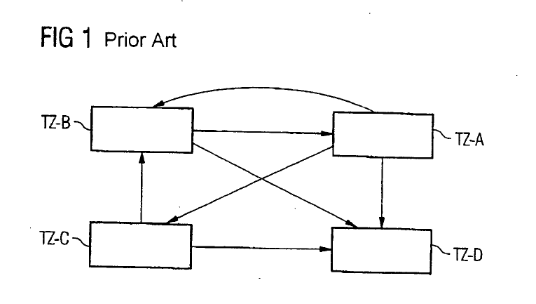

FIG. 1 shows a transition diagram which indicates how a multithread processor based on the prior art switches a thread T between the thread states, specifically a first thread state “being executed” TZ-A, a second thread state “ready to compute” TZ-B, a third thread state “waiting” TZ-C and a fourth thread state “sleeping” TZ-D. The possible transitions from one thread state to another thread state will be described in the following text.

First of all, the individual states will be explained. The first thread state “being executed” TZ-A means that the program instructions for this thread Tⱼ are fetched by the instruction fetch unit BHE from a program instruction memory PBS. Only one thread Tⱼ which is in the first thread state “being executed” TZ-A exists at any time or in each clock cycle.

The second thread state “ready to compute” TZ-B means that a thread Tⱼ is ready to be switched to the first thread state “being executed” TZ-A which, by way of example, means that no instructions or program commands for this thread Tⱼ which is in the second thread state “ready to compute” TZ-B are waiting for external memory accesses.

The third thread state “waiting” TZ-C means that the thread Tⱼ cannot be switched to the first thread state “being executed” TZ-A at that time, for example because it is waiting for external memory accesses or register accesses.

The fourth thread state “sleeping” TZ-D means that the thread Tⱼ is not in any of the three thread states mentioned above.

The following transitions from one thread state to another thread state are possible.

The transition from the first thread state “being executed” TZ-A to the second thread state “ready to compute” TZ-B for the thread Tⱼ:

The transition of the thread Tⱼ from the first thread state “being executed” TZ-A to the second thread state “ready to compute” TZ-B takes place when an explicit start instruction is carried out for another thread T₁, an external interrupt sets the thread Tⱼ to the thread state “ready to compute” TZ-B, or when a timeout occurs for the thread Tⱼ.

The transition from the first thread state “being executed” TZ-A to the fourth thread state “sleeping” TZ-D for the thread Tⱼ:

This transition takes place when a terminating program instruction occurs for the thread Tⱼ.

The transition from the first thread state “being executed” TZ-A to the third thread state “waiting” TZ-C for the thread Tⱼ:

This transition occurs as a result of a switching trigger during a latency time or on the basis of synchronization of the thread Tⱼ to another thread T₁.

The transition from the second thread state “ready to compute” TZ-B to the first thread state “being executed” TZ-A for the thread Tⱼ:

This transition takes place when the thread Tⱼ is selected by an external control program which is managing the switching trigger signals.

The transition from the second thread state “ready to compute” TZ-B to the third thread state “waiting” TZ-C for the thread Tⱼ:

This transition takes place when the thread Tⱼ is ended by an exception or a program instruction.

The transition from the third thread state “waiting” TZ-C to the second thread state “ready to compute” TZ-B:

This transition takes place as a consequence of a thread reactivation signal TRS or of an event control signal.

The transition from the third thread state “waiting” TZ-C to the fourth thread state “sleeping” TZ-D for the thread Tⱼ:

This transition takes place when the thread Tⱼ is ended by an exception or a program instruction.

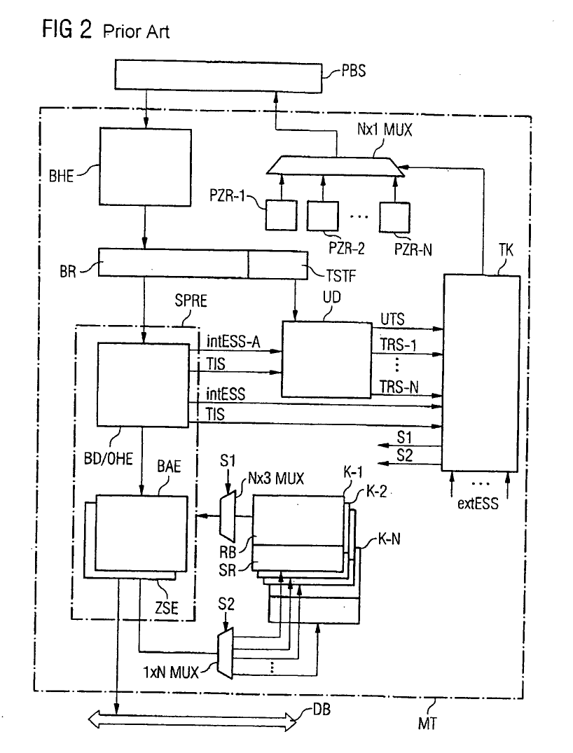

FIG. 2 shows a block diagram of a clocked multithread processor with a switching detector based on a prior art which had not been published by the date of this application.

The multithread processor MT is connected to a program instruction memory PBS and to a data bus DB. Essentially, the multithread processor MT has a standard processor root unit SPRE, N context memories K, a thread monitoring unit TK, a switching detector UD, an instruction fetch unit BHE, an instruction register BR and an N×1 multiplexer N×1-MUX.

The standard processor root unit SPRE is organized on the basis of the pipeline principle according to von Neumann. The pipeline for the standard processor root unit SPRE has an instruction decoder/operand fetch unit BD/OHE, an instruction execution unit BAE and a write-back unit ZSE.

Each of the N context memories K has a program counting register PZR, a register bank RB and a status register SR.

As is known, operands and status flags are provided on a clock-cycle-sensitive basis to the pipeline stage for the standard processor root unit SPRE by means of the N×3 multiplexer N×3-MUX via the register banks RB and the status registers SR for the context memories K.

After the pipeline stage of the instruction processing unit BAE, the write-back unit ZSE writes operation results and status flags via a 1×N Multiplexer 1×N-MUX to the corresponding context memory K, to the corresponding register bank RB and to the corresponding status register SR. Furthermore, the write-back unit ZSE makes the calculated operation results and status flags available to external memories via the data bus DB.

The program counting registers PZR for the context memories K address the program commands or instructions to be read. The thread monitoring unit TK controls which program instructions relating to the thread to be processed should be read, via the N×1 multiplexer N×1-MUX. The N×1 multiplexer N×1-MUX reads the addresses of the program instructions from the program counting register PZR-i relating to the thread Tᵢ to be processed. The addresses of the program instructions to be read are transferred from the N×1 multiplexer N×1-MUX to the program instruction memory PBS. The instruction fetch unit BHE reads the addressed program instructions to be read from the program instruction memory PBS, and temporarily stores them in an instruction register BR.

The instruction decoder/operand fetch unit BD/OHE in each case fetches one program instruction from the instruction register BR, and decodes it. If the decoded program instruction is a switching program instruction, the instruction decoder/operand fetch unit generates an internal event control signal intESS-A for a switching program instruction, and sends this signal to the switching detector UD. The program instruction is processed in the following pipeline stages in a corresponding manner to that in the published prior art.

The switching detector UD reads the thread switching trigger data field TSTF for a program instruction from the instruction register BR. If the value of the thread switching trigger data field TSTF which has been read is not equal to zero, or if there is an internal event control signal intESS-A for a switching program instruction, the switching detector UD generates a switching trigger signal UTS and sends this to the thread monitoring unit TK. In addition, the switching detector UD sets the thread Tⱼ which is addressed by the thread switching trigger data field TSTF or by an internal event control signal intESS-A for a switching program instruction to the thread state “waiting” PZ-C. Once the total of N delayed clock cycles have elapsed, the switching detector UD generates a thread reactivation signal TRS-j for the corresponding thread. Tⱼ, and sends this to the thread monitoring unit TK.

The thread monitoring unit TK generates a control signal S1 in order to control the N×3 multiplexer N×3-MUX, and generates a control signal S2 in order to control the 1×N multiplexer 1×N-MUX.

The thread monitoring unit TK receives the switching trigger signals UTS as well as the thread reactivation signals TRS and an external event control signal extESS and uses them to generate an optimized sequence of threads to be processed. The N×1 multiplexer N×1-MUX is driven by means of the optimized sequence of threads to be processed. The switching detector UD essentially has a delay circuit and a trigger circuit. The function of the delay circuit is to delay the thread addressed by the switching trigger signal by the total of n delayed clock cycles.

One disadvantage of this unpublished prior art is that the addition of the thread switching trigger data field TSTF to the conventional instruction format means that a longer instruction format must be processed by the multithread processor. A longer instruction format means more data memory, for example in the instruction register BR and in the units in the standard processor root unit. An increased memory space requirement is critical for the development and use of embedded processors.

The object of the present invention is thus to provide a multithread processor which can be switched between a number of threads without any clock cycle loss, without any additional switching program instruction being required, and without a conventional program instruction format for the multithread processor being extended.

The idea on which the present invention is based essentially comprises a program instruction which will result in a latency time for the standard processor root unit being identified even before the actual decoding of this program instruction by the standard processor root unit as a program instruction which implies a latency time, with this being used as the basis for switching from the thread which has the program instruction that implies a latency time to another thread. For this purpose, according to the invention, a clocked multithread processor for data processing of N threads is provided with a standard processor root unit, wherein a thread Tⱼ to be processed at that time by the standard processor root unit can be switched without any clock cycle loss by means of a switching trigger signal to another thread T₁, wherein the switching trigger signal is generated as a consequence of a program instruction (which is fetched from a program instruction memory and implies a latency time) for the thread Tⱼ which is to be processed at that time and results in a latency time for the standard processor root unit, before the program instruction which has been fetched and implies a latency time is decoded by the standard processor root unit.

One advantage of the arrangement according to the invention is, in particular, that the multithread processor makes use of the latency time which is caused by a program instruction blocking the standard processor root unit in order to process program instructions for other threads.

The dependent claims contain advantageous developments of the multithread processor architecture for thread switching without any clock cycle loss, without any additional switching program instruction and without extending the program instruction format.

According to one preferred development, a thread T is in a first thread state “being executed”, in a second thread state “ready to compute”, in a third thread state “waiting” or in a fourth thread state “sleeping”.

According to a further preferred development, the program instruction which implies a latency time for the thread Tⱼ implicitly includes switching information for the thread Tⱼ which indicates whether the thread Tⱼ is switched from the first thread state “being executed” to the third thread state “waiting”, and the total of n delayed clock cycles for which the thread Tⱼ is held in the third thread state “waiting”.

One advantage of this development is that threads can be switched within a multithread processor without extending the program instruction format provided for the standard processor root unit.

According to a further preferred development, the switching information can be detected from a program instruction which implies a latency time, from a switching program instruction which is provided specifically in the program instruction memory, or from a program instruction to which a thread switching trigger data field has been added.

One advantage of this preferred development is that the switching information can be obtained from any sources of the instruction code provided that the program instruction in question will cause a latency time with a deterministic occurrence.

According to a further preferred development, the multithread processor has an initial decoding unit, which uses the switching information for the thread Tⱼ to generate the switching trigger signal for the thread Tⱼ, and which delays the thread Tⱼ for the total of n delayed clock cycles.

One advantage of this preferred development is that the initial decoding unit uses a program instruction which implies a latency time, by means of hardware wiring or a look-up table, to detect whether the corresponding thread should be switched in response to the decoded program instruction, and the number n of delayed clock cycles for which the corresponding thread Tⱼ should be delayed. Both hardware wiring and an implementation based on a look-up table assist the initial decoding unit in achieving a real-time capability.

According to one preferred development, the initial decoding unit has a detection logic unit which uses the switching information for the thread Tⱼ to generate the switching trigger signal for the thread Tⱼ and a delay signal for the thread Tⱼ, which indicates the total of n delayed clock cycles.

One advantage of this preferred development is that the detection logic unit is the location of the abovementioned hardware wiring or the location for the detection by means of a look-up table.

According to a further preferred development, the initial decoding unit has a delay circuit in which a delay path, which in each case delays the corresponding thread to be switched for a total of n delayed clock cycles, is provided for each of the N threads.

According to a further preferred development, the delay circuit has a first 1×N multiplexer, which passes the switching trigger signal for the thread Tⱼ to the corresponding delay path, so that the corresponding delay path is triggered by the switching trigger signal.

According to a further preferred development, the delay circuit has a second 1×N multiplexer, which passes the delay signal for the thread Tⱼ to the corresponding delay path, so that the corresponding delay path delays the thread Tⱼ for the total of n delayed clock cycles.

According to a further preferred development, the delay path for the corresponding thread Tⱼ generates a thread reactivation signal for the thread Tⱼ once the total of n delayed clock cycles have elapsed.

According to a further preferred development, the multithread processor has a thread monitoring unit, which controls the sequence of program instructions to be processed by the standard processor root unit for the various threads as a function of the switching trigger signal and of the thread reactivation signals such that switching between threads takes place without any clock cycle loss in that the switching trigger signal for the thread Tⱼ switches the thread Tⱼ from the first thread state “being executed” to the third thread state “waiting” and switches a thread T₁ from the second thread state “ready to compute” to the first thread state “being executed”, and in that the thread reactivation signal for the thread Tⱼ switches the thread Tⱼ from the third thread state “waiting” to the second thread state “ready to compute”.

According to a further preferred development, the multithread processor has a program instruction fetch unit for fetching program instructions Iⱼₖ for at least one thread Tⱼ from the program instruction memory.

According to a further preferred development, the multithread processor has at least one program instruction buffer store, which can be split into N program instruction buffer stores, which can be addressed by the thread monitoring unit.

According to a further preferred development, the thread monitoring unit has a third 1×N multiplexer which can be controlled by means of a first multiplexer control signal such that the program instruction Iⱼₖ fetched by the program instruction fetch unit for the thread Tⱼ is temporarily stored in the corresponding program instruction buffer store for the thread Tⱼ.

According to a further preferred development, the thread monitoring unit controls a first N×1N multiplexer by means of a second multiplexer control signal such that the fetched program instruction Iⱼₖ for the thread Tⱼ, which is temporarily stored in the corresponding program instruction buffer store, is transferred by means of the first N×1 multiplexer to the detection logic unit for the initial decoding unit.

According to a further preferred development, the thread monitoring unit controls a second N×1 multiplexer by means of a third multiplexer control signal such that the fetched program instruction Iⱼₖ for the thread Tⱼ, which is temporarily stored in the corresponding program instruction buffer store, is transferred by means of the second N×1 multiplexer to the standard processor root unit.

According to a further preferred development, the standard processor root unit is intended for sequential instruction execution of the temporarily stored program instruction, with the standard processor root unit being clocked by a clock signal with a predetermined clock cycle time.

According to a further preferred development, the thread monitoring unit controls a third N×1 multiplexer by means of a fourth multiplexer control signal such that program instructions Iⱼₖ for a thread Tⱼ, which is in the first thread state “being executed”, are read from the program instruction memory and are processed by the standard processor root unit.

According to a further preferred development, the thread monitoring unit controls the third N×1 multiplexer by means of the fourth multiplexer control signal such that program instructions Iⱼₖ for a thread Tⱼ, which is in the second thread state “ready to compute”, are read from the program instruction memory and are processed by the standard processor root unit provided that no other thread T₁ is in the first thread state “being executed”.

According to a further preferred development, the thread monitoring unit controls the third N×1 multiplexer by means of the fourth multiplexer control signal such that program instructions Iⱼₖ for a thread Tⱼ, which is in the third thread state “waiting”, are not read from the program instruction memory and are not processed by the standard processor root unit until the thread monitoring unit receives the thread reactivation signal for the thread Tⱼ and switches that thread Tⱼ to the second thread state “ready to compute”, and until no other thread T₁ is in the first thread state “being executed”.

According to a further preferred development, the thread monitoring unit controls the third N×1 multiplexer by means of the fourth multiplexer control signal such that program instructions Iⱼₖ for a thread Tⱼ, which is in the fourth thread state “sleeping”, cannot be read from the program instruction memory, and cannot be processed by the standard processor root unit.

According to a further preferred development of the invention, the thread reactivation signal for the thread Tⱼ triggers switching of the thread Tⱼ from the third thread state “waiting” to the second thread state “ready to compute” after the total of n delayed clock cycles for the delay path have elapsed.

According to a further preferred development, the standard processor root unit has a program instruction decoder/operand fetch unit for decoding a program instruction Iⱼₖ and for fetching operands addressed within the program instruction Iⱼₖ, a program instruction execution unit for carrying out the decoded program instruction Iⱼₖ, and a write-back unit for writing back operation results.

According to a further preferred development, a number (N) of context memories are provided in the multithread processor, and each temporarily stores one current context for a thread.

According to a further preferred development, the thread monitoring unit controls an N×3 multiplexer by means of a sixth multiplexer control signal, such that the operands addressed within the program instruction Iⱼₖ are passed to the appropriate unit in the standard processor root unit by the appropriate context memory.

According to a further preferred development, each context memory has a program counting register for temporary storage of a program counter, a register bank for temporary storage of operands, and a status register for temporary storage of status signal elements.

According to a further preferred development, the total of N context memories is predetermined.

According to a further preferred development, the memory contents of the program counting register, of the register bank and of the status register indicate the context of the corresponding thread.

According to a further preferred development, the program instruction fetch unit is connected to the program instruction memory in order to read program instructions, with the program instructions which are read from the program instruction memory being addressed by the program counting registers for the context memories.

According to a further preferred development, the standard processor root unit emits the processed data via a data bus to a data memory.

According to a further preferred development, the thread monitoring unit controls a fourth 1×N multiplexer by means of a fifth multiplexer control signal such that the data which has been processed by means of the standard processor root unit is stored in the corresponding context memory.

According to a further preferred development, the standard processor root unit processes the program instructions passed to it from the thread monitoring unit sequentially using a pipeline method.

According to a further preferred development, the standard processor root unit processes a program instruction that is to be processed, within a predetermined number of clock cycles.

According to a further preferred development, the thread monitoring unit receives external event control signals which are produced by external assemblies.

According to a further preferred development, the standard processor root unit is a part of a DSP processor, of a protocol processor or of a universal processor (general purpose processor).

According to a further preferred development, the program instruction execution unit for the standard processor root unit contains an arithmetic logic unit (ALU) and/or an address generator unit (AGU).

According to a further preferred development, the thread monitoring unit controls switching networks as a function of the event control signals, in order to control the N threads by means of their corresponding thread states.

According to a further preferred development, the first multiplexer control signal and the third multiplexer control signal are identical.

According to a further preferred development, the second multiplexer control signal and the seventh multiplexer control signal are identical.

According to a further preferred development, the first multiplexer control signal and the third multiplexer control signal are in each case the second multiplexer control signal and the seventh multiplexer control signal delayed by one clock cycle.

One advantage of this preferred development is that only one multiplexer control signal is thus required overall for the four multiplexer control signals, the first multiplexer control signal, the second multiplexer control signal, the third multiplexer control signal and the seventh multiplexer control signal, with this single multiplexer control signal additionally being delayed by one clock cycle.

According to a further preferred development, the thread monitoring unit controls the first 1×N multiplexer and the second 1×N multiplexer synchronously by means of a seventh multiplexer control signal.

Exemplary embodiments of the invention will be explained in more detail in the following description and are illustrated in the drawings. Identical reference symbols in the figures denote identical or functionally identical elements.

In the figures:

FIG. 1 shows a transition diagram for all the potential thread states of a thread according to the prior art.

FIG. 2 shows a block diagram of a multithread processor with a switching detector according to an unpublished prior art.

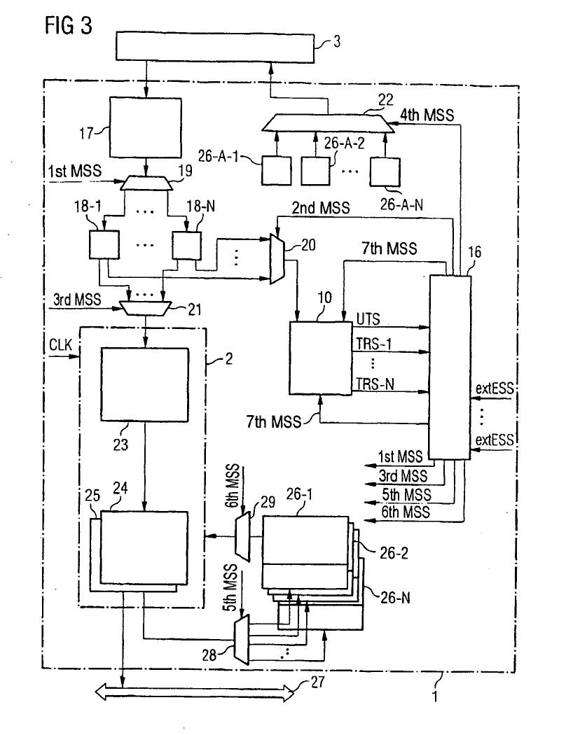

FIG. 3 shows a block diagram of a multithread processor according to the invention with an initial decoding unit.

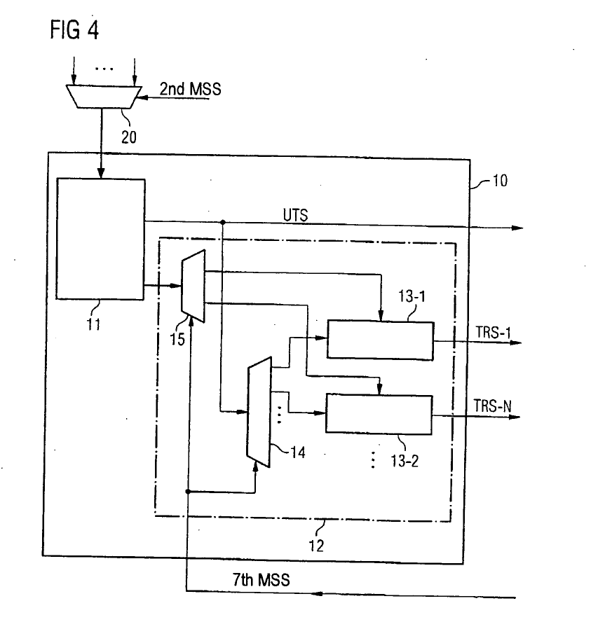

FIG. 4 shows a detailed block diagram of the initial decoding unit according to the invention.

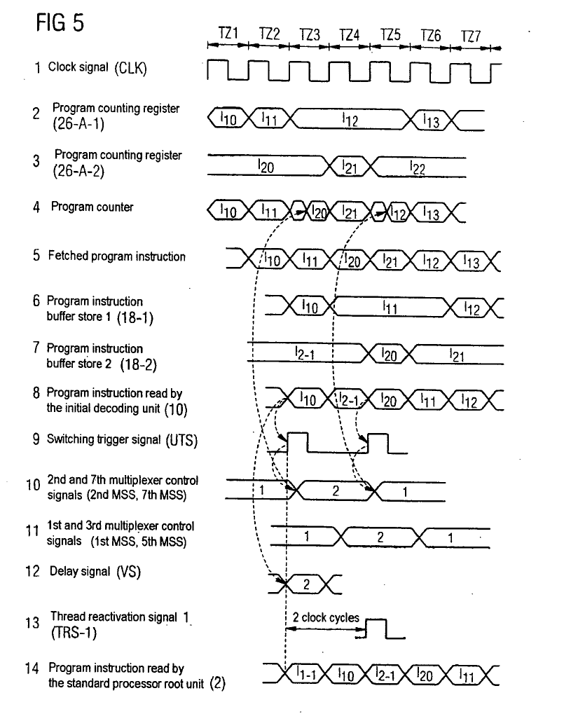

FIG. 5 shows a flow chart of the process of switching between two threads by means of the multithread processor according to the invention.

Although the present invention is described in the following text with reference to processors or microprocessors and their architectures, it is not restricted to them but can be used in many ways.

FIG. 3 shows a block diagram of a multithread processor 1 according to the invention with an initial decoding unit 10. The multithread processor 1 is connected to a program instruction memory 3 and to a data bus 27. The multithread processor 1 essentially has a standard processor root unit 2, N context memories 26, a thread monitoring unit 16, an initial decoding unit 10, a program instruction fetch unit 17, N program instruction buffer stores 18, 1×N multiplexers (14, 15, 19, 28), N×1 multiplexers (20, 21, 22) and an N×3 multiplexer (29).

The standard processor root unit 2 is organized identically to the unpublished prior art shown in FIG. 2, based on the pipeline principle according to Von Neumann. The pipeline for the standard processor root unit 2 has a program instruction decoder/operand fetch unit 23, a program instruction execution unit 24 and a write-back unit 25.

Each of the N context memories 26 has a program counting register 26-A, a register bank 26-B and a status register 26-C. Operands and status flags are provided by means of the N×3 multiplexer for the pipeline stages for the standard processor root unit 2 via the register banks 26-B and the status registers 26-C for the context memories 26.

After the pipeline stage of the program instruction execution unit 24, the write-back unit 25 writes the operation results and status flag via the fourth 1×N multiplexer 28 to the corresponding context memory 26, to the corresponding register bank 26-B and to the corresponding status register 26-C. In addition, the write-back unit 25 makes the calculated operation results and status flags available to external memories or units via a data bus 27.

The program counting registers 26-A for the context memories 26 address the program instructions to be read. The thread monitoring unit 16 controls which program instructions relating to the thread to be processed should be read, via the third N×1 multiplexer 22.

The third N×1 multiplexer 22 reads the addresses of the program instructions from the program counting register 26-A-i relating to the thread Tⱼ to be processed. The addresses of the program instructions to be read are transferred via an address line from the third N×1 multiplexer 22 to the program instruction memory 3.

The program instruction fetch unit 17 reads the addressed program instructions to be read from the program instruction memory 3. These program instructions are temporarily stored via the third 1×N multiplexer 19 in the corresponding program instruction buffer store 18-j for the thread Tⱼ.

The program instruction which is temporarily stored in the corresponding program instruction buffer store 18-j for the respective clock cycle is passed via the first N×1 multiplexer 20 to the initial decoding unit 10. If the program instruction that has been passed on is a program instruction which implies a latency time, than the initial decoding unit 10 extracts the switching information 8 from it.

In the case of a program instruction which implies a latency time, a switching trigger signal UTS is generated from the switching information 8 for the thread Tⱼ to be processed at that time, and the thread Tⱼ to be processed at that time is delayed for the total of n delayed clock cycles 9.

Once the total of n delayed clock cycles 9 have elapsed, the initial decoding unit 10 generates a thread reactivation signal TRS-j for the corresponding thread Tⱼ, and sends this to the thread monitoring unit 16.

The thread monitoring unit 16 controls the sequence of the program instructions for the various threads to be processed by the standard processor unit 2, as a function of the switching trigger signal UTS and of the thread reactivation signals which it receives from the initial decoding unit 10, such that switching takes place between threads without any clock cycle loss, via the switching trigger signal UTS for the thread Tⱼ switching the thread Tⱼ to be processed at that time from the first thread state “being executed” 4 in the third thread state “waiting” 6, and switching another thread T₁ from the second thread state “ready to compute” 5 to the first thread state “being executed” 4, and by the thread reactivation signal TRS-j for the thread Tⱼ switching the thread Tⱼ to be processed at that time from the third thread state “waiting” 6 to the second thread state “ready to compute” 5.

In order to ensure that the various multiplexers load the suitable program instruction into the appropriate unit on a clock-cycle-sensitive basis, the thread monitoring unit 16 controls the appropriate multiplexers by means of multiplexer control signals (1st MSS, 2nd MSS, 3rd MSS, 4th MSS, 5th MSS, 6th MSS, 7th MSS).

The third N×1 multiplexer 22 is driven by the fourth multiplexer control signal 4th MSS by means of the optimized sequence of threads to be processed.

FIG. 4 shows a detailed block diagram of the initial decoding unit 10 according to the invention.

The initial decoding unit 10 has a detection logic unit 11 and a delay circuit 12.

The initial decoding unit 10 receives the program instructions for the thread to be processed at that time, via the first N×1 multiplexer 20, from the program instruction buffer store 18-j for the thread Tⱼ to be processed at that time.

The first N×1 multiplexer 20 is controlled by the thread monitoring unit 16 (not shown) by means of the second multiplexer control signal 2nd MSS.

The program instruction which is passed to the initial decoding unit 10 is received by the detection logic unit 11. A detection process is carried out within the detection logic 11 by means of hardware wiring or an implementation in the form of a look-up table to determine whether the received program instruction is a program instruction which implies a latency time.

If the detection logic unit 11 detects that this is a program instruction which implies a latency time, it generates a switching trigger signal UTS and sends the switching trigger signal UTS to the thread monitoring unit 16 (not shown). Furthermore, the detection logic unit 11 uses the hardware wiring or the implementation in the form of a look-up table to detect a delay signal VS, which indicates the number n of delayed clock cycles 9 for which the thread Tⱼ to be processed at that time will be delayed.

The switching trigger signal UTS for the thread Tⱼ to be processed at that time is passed by means of the first 1×N multiplexer 14 to the delay path 13-j, in order to trigger this delay path 13-j. At the same time, the delay signal VS for the thread Tⱼ to be processed at that time is passed by means of the second 1×N multiplexer 15 to the delay path 13-j for the thread Tⱼ to be processed at that time, in order to keep the thread Tⱼ in the delay path 13-j for the total of n delayed clock cycles 9. Once the total of n delayed clock cycles 9 have elapsed, the delay path 13-j will send a thread reactivation signal TRS-j for the thread Tⱼ to the thread monitoring unit 16 (not shown).

The thread monitoring unit 16 (not shown) controls the first 1×N multiplexer 14 and the second 1×N multiplexer 15 synchonously by means of a seventh multiplexer control signal 7th MSS.

FIG. 5 shows a flowchart of a switching process according to the invention between two threads, by means of the multithread processor according to the invention.

The exemplary embodiment shown in FIG. 5 relates to a multithread processor 1 according to the invention, which can be switched between two threads T_{1 and T}₂. The multithread processor 1 according to the invention is a multithread processor 1 which is clocked by the clock signal CLK. The clock signal CLK subdivides the flowchart into the clock cycles TZ1, TZ2, etc.

The two threads T₁ and T₂ are respectively represented by their program counting registers 26-A-1, 26-A-2.

The program counter (see line 4 in the flowchart) for the multithread processor indicates the address from which the corresponding program instruction Iⱼₖ should be read from the program instruction memory.

For the clock cycle TZ1, the program counter for the multithread processor 1 contains the program instruction I₁₀ for the thread T₁. The program instruction I₁₀ is thus fetched by the program instruction fetch unit 17 in the next clock cycle TZ2 with the “fetched program instruction” line in FIG. 5 indicating that the program instruction I₁₀ is fetched in the second clock cycle TZ2.

The program instruction I₁₀ is temporarily stored in the program instruction buffer store 18-1 for the thread T₁ in the next clock cycle TZ3.

Each register content, memory content or buffer-store content is in each case stable and can be read at the start of a rising flank of the clock signal CLK.

The program instruction I₁₀ for the thread T₁ is accordingly read by the initial decoding unit 10 in the clock cycle TZ3 (in this context, see the “program instruction read by the initial decoding unit 10” line relating to the clock cycle TZ3).

This example of the flowchart as shown in FIG. 5 is based on the assumption that the 0-th program instruction Iⱼₒ for a thread Tⱼ is in each case a program instruction which implies a latency time.

The initial decoding unit 10 will accordingly generate a switching trigger signal UTS for the clock cycle TZ3 (see line 9 in the flowchart shown in FIG. 5 relating to the clock cycle TZ3).

Because the switching trigger signal UTS is set to one, the second and the seventh multiplexer control signals 2nd MSS and 7th MSS are switched from the thread T₁ to the thread T₂ in order to control the corresponding multiplexer. After line 11 in the flowchart, the first and third multiplexer control signals 1st MSS and 3rd MSS, which are each in the form of the delayed second multiplexer control signal, are switched from the thread T₁ (1) to the thread T₂ (2) in the clock cycle TZ4.

Furthermore, the initial coding unit 10 generates a delay signal VS for the thread T₁ for the clock cycle TZ3. For this example, it is assumed that the program instruction I₁₀, which implies a latency time, for the thread T₁ will cause a latency time of two clock cycles. Accordingly, the value of the delay signal VS is set to the value 2 after the line 12 in the flowchart, which relates to the clock cycle 3. Line 13 shows that, once two clock cycles have elapsed after the clock cycle TZ3, a thread reactivation signal TRS-1 will be generated for the thread T₁ after the two clock cycles (delay signal=2) have elapsed, relating to the clock cycle TZ5.

Analogously, the program instruction I₂₀ for the thread T₂ relating to the clock cycle TZ5 will cause a latency time for the multithread processor.

Once the thread T₁ has already been activated again by the thread reactivation signal TRS-1 for this clock cycle, a program instruction for the thread T₁, specifically the program instruction I₁₁, is then read by the standard processor root unit 2 following the program instruction I₂₀ for the thread T₂, and is carried out (see line 14 as shown in FIG. 5).

Although the present invention has been described above with reference to preferred exemplary embodiments, it is not restricted to them but can be modified in many ways.

1-42. (canceled)

43. A clocked multithread processor for data processing of N threads, the multithread processor comprising a standard processor root unit operable to process threads, and a fetch unit operable to fetch program instructions, wherein the standard processor root unit is configured to be switched from a thread Tⱼ to another thread T₁ substantially without any clock cycle loss using a switching trigger signal, and wherein the switching trigger signal is generated responsive to a fetched program instruction, the fetched program instruction corresponding to a latency time of the standard processor root unit, the switching trigger signal being generated before the fetched program instruction is decoded by the standard processor root unit.

44. The multithread processor according to claim 43, wherein each thread to be processed is in one of a plurality of states, said states including a first thread state in which the thread is being executed, a second thread state in which the thread is ready to compute, a third thread state in which the thread is waiting, and a fourth thread state in which the thread is sleeping.

45. The multithread processor according to claim 44, wherein switching information can be generated from the fetched program instruction, the switching information indicating that the thread Tⱼ to be processed at that time is switched from the first thread state to the third thread state, and further indicating a quantity of delayed clock cycles for which the thread Tⱼ is held in the third thread state.

46. The multithread processor according to claim 45, wherein at least some program instructions include specified switching information indicating that a current thread should be switched from the first thread state to the third thread state, and that a specified quantity of delayed clock cycles that the current thread should remain in the third thread state.

47. The multithread processor according to claim 43, further comprising an initial decoding unit operable to generate the switching trigger signal, and operable to cause the thread Tⱼ to be delayed for a quantity of delayed clock cycles.

48. The multithread processor according to claim 47, wherein switching information may be derived from the fetched program instruction, and wherein the initial decoding unit has a detection logic unit operable to use the switching information to generate the switching trigger signal and a delay signal for the thread Tⱼ, the delay signal operable to cause the thread Tⱼ to be delayed for the quantity of delayed clock cycles.

49. The multithread processor according to claim 47, wherein the initial decoding unit includes a delay circuit operable to delay the thread Tⱼ for the quantity of delayed clock cycles, the delay circuit including a delay path for each of the N threads.

50. The multithread processor according to claim 49, wherein the delay circuit further includes a first 1×N multiplexer configured to pass the switching trigger signal for the thread Tⱼ to the corresponding delay path, so as to trigger the corresponding delay path.

51. The multithread processor according to claim 50, wherein the delay circuit further includes a second 1×N multiplexer configured to pass a delay signal for the thread Tⱼ to the corresponding delay path, the delay signal operable to cause the corresponding delay path to delay the thread Tⱼ for the quantity of delayed clock cycles.

52. The multithread processor according to claim 50, wherein the corresponding delay path is configured to generate a thread reactivation signal for the thread Tⱼ once the quantity of delayed clock cycles have elapsed.

53. The multithread processor according to claim 45, further comprising a thread monitoring unit configured to control a sequence of program instructions to be processed by the standard processor root unit for the various threads such that switching between threads takes place without any clock cycle loss, the thread monitoring unit operable to, responsive to the switching trigger signal, switch the thread Tⱼ from the first thread state to the third thread state, and switch the thread T₁ from the second thread state to the first thread state, the thread monitoring unit further operable to, responsive to a thread reactivation signal for the thread Tⱼ, switch the thread Tⱼ from the third thread state to the second thread state.

54. The multithread processor according to claim 53, further comprising a buffer circuit including N program instruction buffer stores configured to be controlled by the thread monitoring unit.

55. The multithread processor according to claim 54 wherein:
the buffer circuit further comprises a 1×N multiplexer that causes the fetched program instruction to be temporarily stored in a select one the N buffer stores responsive to a first multiplexer control signal generated by the thread monitoring unit.

56. The multithread processor according to claim 55, wherein the buffer circuit further comprises a first N×1 multiplexer configured to provide the fetched instruction program stored in the select one of the N buffer stores to an initial decoding unit of multithread processor responsive to a second multiplexer control signal received from the thread monitoring unit, and wherein the initial decoding unit is operable to generate the switching trigger signal.

57. The multithread processor according to claim 56, wherein the buffer circuit further includes a second N×1 multiplexer configured to provide the fetched instruction program stored in the select one of the N buffer stores to the standard processor root unit responsive to a third multiplexer control signal.

58. The multithread processor according claim 43 wherein the standard processor root unit is clocked by a clock signal with a predetermined clock cycle time.

59. The multithread processor according to claim 53, further comprising an N×1 multiplexer operable to, responsive to a multiplexer control signal generated by the thread monitoring unit, cause program instructions for the thread Tⱼ to be read from a program instruction memory when the thread Tⱼ is in the first thread state.

60. The multithread processor according to claim 59, wherein the thread monitoring unit is further operable to cause the N×1 multiplexer to read program instructions for the thread Tⱼ from the program instruction memory when the thread Tⱼ is in the second thread state and no other thread is in the first thread state.

61. The multithread processor according to claim 59, wherein the thread monitoring unit is further operable to cause the N×1 multiplexer to read program instructions for only threads other than the thread Tⱼ from the program instruction memory when the thread Tⱼ is in the third thread state.

62. The multithread processor according to claim 59, wherein the thread monitoring unit is further operable to cause the N×1 multiplexer to read program instructions for only threads other than the thread Tⱼ from the program instruction memory when the thread Tⱼ is in the fourth thread state.

63. The multithread processor according to claim 52, wherein the thread reactivation signal for the thread Tⱼ causes switching of the thread Tⱼ from the third thread state to the second thread state.

64. The multithread processor according to claim 43 wherein the standard processor root unit includes:
a program instruction decoder/operand fetch unit configured to decode the fetched program instruction and to fetch at least one operand addressed within the fetched program instruction;
a program instruction execution unit configured to execute the decoded program instruction; and
a write-back unit configured to write back operation results.

65. The multithread processor according to claim 64 further comprising N of context memories, each operable to store one current context for a corresponding thread.

66. The multithread processor according to claim 65 further comprising a multiplexer configured to pass the at least one operand addressed within the fetched program instruction to the standard processor root unit from a corresponding context memory.

67. The multithread processor according to claim 64 further comprising N of context memories, each operable to store one current context for a corresponding thread, the total of N context memories being predetermined.

68. The multithread processor according to claim 43 wherein the standard processor root unit is configured to provide processed data via a data bus to a data memory.

69. The multithread processor according to claim 53, wherein the standard processor root unit processes the sequence of program instructions using a pipeline method.

70. The multithread processor according to claim 69, wherein the standard processor root unit processes each program instruction that is to be processed within a predetermined number of clock cycles.

71. The multithread processor according to claim 43, wherein the fetched program instruction is associated with the latency time through a correlation of the fetched program instruction and a priori knowledge of latency times associated with the fetched program instruction.

72. The multithread processor accordingly to claim 43, wherein the fetched program instruction implies a latency time.
